(19) United States
(12) Patent Application Publication
(10) Pub. No.: US 2022/0245566 A1
(43) Pub. Date: Aug. 4, 2022

(54) SYSTEMS AND METHODS FOR DISTRIBUTED DROP SHIPPING

(71) Applicant: Aleran Software, Inc., Minneapolis, MN (US)

(72) Inventors: Sassan Alex Sayyah, Minneapolis, MN (US); Alexander Simon Kushner, Plymouth, MN (US)

(21) Appl. No.: 17/591,501

(22) Filed: Feb. 2, 2022

Related U.S. Application Data
(60) Provisional application No. 63/184,004, filed on May 4, 2021.
(60) Provisional application No. 63/145,867, filed on Feb. 4, 2021.

(51) Int. Cl. G06Q 10/08

(52) U.S. Cl. CPC G06Q 10/083

(57) ABSTRACT

The present disclosure provides computer-implemented systems and methods for distributed drop shipping. A distributed drop shipping method may comprise (a) enrolling a plurality of retailers in a distributed dropship program; (b) receiving a product order from a user, wherein the user has a location; (c) identifying one or more retailers of the plurality of retailers within a maximum distance from the location that have the product in stock by analyzing a live inventory feed from each of the plurality of retailers or an order history of each of the plurality of retailers; (d) transmitting, to a subset of the one or more retailers, a fulfilment request; (e) receiving a fulfilment response from a retailer of the subset of retailers; and (f) based at least in part on a live inventory feed of the retailer and the product order, determining whether to initiate a replenishment order for the retailer.

### PRIORITY

This application claims priority to U.S. Provisional Patent Application Nos. 63/184,004, filed May 4, 2021, and 63/145,867, filed Feb. 4, 2021, both of which are entirely incorporated herein by reference.

### BACKGROUND

A drop shipper is a retailer that accepts product orders but passes those orders to a manufacturer to fulfill and ship. Drop shippers may not need to hold inventory or even have a brick-and-mortar retailer front. However, drop shipping may be expensive for manufacturers because they may be required to ship individual items to customers and lose out on economies of scale.

### SUMMARY

The present disclosure provides computer-implemented systems and methods for distributed drop shipping. A manufacturer may enroll retailers in a distributed drop shipping program. By enrolling in the distributed drop shipping program, the retailers agree to buy one or more products from the manufacturer and sell those products to customers. The manufacturer may operate a business-to-consumer (B2C) e-commerce website. When a customer places an order on the B2C website, the distributed drop shipping system described herein can identify one or more retailers that are enrolled in the disturbed drop shipping program that are within a maximum distance from the customer's location and have the product in stock. The distributed drop shipping system can determine whether a particular retailer has the product in stock by analyzing the live inventory feed of the retailer. The distributed drop shipping system can transmit a fulfilment request to a subset of the one or more retailers it identified. One of the retailers may fulfill the fulfillment request. By fulfilling the fulfillment request, the retailer may agree to sell and ship the product to the customer. In return, the retailer may receive payment from the customer, either directly or through the B2C website. The manufacturer may receive a technology fee from the retailer. The manufacturer may determine whether to initiate a replenishment order for the retailer based on the inventory feed of the retailer and the product order.

In conventional drop shipping, a manufacturer may be required to ship small orders or even single items directly to customers, which may be expensive for the manufacturer. Using the systems and methods described herein, a manufacturer can instead ship large orders to retailers who are enrolled in the distributed drop shipping program. This allows the manufacturer to leverage economies of scale. The distributed drop shipping program also reduces shipping time and aggregate shipping distances because customers can get products from local retailers rather than waiting for long distance shipments from the manufacturer's regional warehouse.

One aspect of the present disclosure provides a computer-implemented method. The method may comprise (a) enrolling a plurality of retailers in a distributed dropship program; (b) receiving a product order from a user (e.g., a consumer), wherein the user has a location; (c) identifying one or more retailers of the plurality of retailers within a maximum distance from the location that have the product in stock by analyzing a live inventory feed from each of the plurality of retailers or an order history of each of the plurality of retailers; (d) transmitting, to a subset of the one or more retailers, a fulfilment request; (e) receiving a fulfilment response from a retailer of the subset of retailers; and (f) based at least in part on a live inventory feed of the retailer and the product order, determining whether to initiate a replenishment order for the retailer.

In some embodiments, (c) further comprises analyzing an order history of each of the plurality of retailers. In some embodiments, (c) further comprises analyzing the live inventory feed from each of the plurality of retailers and the order history of each of the plurality of retailers. In some embodiments, the method further comprises analyzing a prediction of future product orders from each of the plurality of retailers. In some embodiments, the method further comprises, prior to (d), ranking the plurality of retailers to determine the subset of retailers. In some embodiments, the ranking is based at least in part on a distance from each of the plurality of retailers to the location. In some embodiments, the ranking is based at least in part on weather at the location and at each of the plurality of retailers. In some embodiments, the ranking is based at least in part on availability of drivers at each of the plurality of retailers. In some embodiments, the ranking is based at least in part on a distance of the drivers to each of the plurality of retailers. In some embodiments, the ranking is based at least in part on traffic between each of the plurality of retailers and the location.

In some embodiments, (e) comprises receiving a plurality of fulfilment responses from a plurality of retailers including the retailer. In some embodiments, the method further comprises transmitting a confirmation only to the retailer. In some embodiments, the retailer is a first retailer among the plurality of retailers to send the fulfilment response. In some embodiments, the method further comprises receiving shipping info from the retailer. In some embodiments, the product order is an online order.

In some embodiments, the method further comprises maintaining a database of the plurality of retailers comprising data comprising location, products, shipping capabilities, and real-time inventory metrics for each of the plurality of retailers. In some embodiments, the method further comprises obtaining the location of the user automatically from an electronic device of the user. In some embodiments, determining whether to initiate a replenishment order for the retailer is further based at least in part on an order history of the retailer. In some embodiments, determining whether to initiate a replenishment order is performed periodically for each of the plurality of retailers. In some embodiments, if a fulfillment response is not received in (e), the method further comprising repeating (c) and (d) until a fulfillment response is received.

In some embodiments, the user is a consumer. In some embodiments, the plurality of retailers comprises a plurality of autonomous retailers. In some embodiments, the plurality of autonomous retailers can comprise a plurality of retailers, each of which are different from one another

Another aspect of the present disclosure provides a distributed drop shipping system. In some embodiments, the system comprises: a user application on an electronic device of a user; one or more computer processors communicatively coupled to (i) the electronic device of the user and (ii) a plurality of point of sale (POS) systems of a plurality of retailers; In some embodiments, the user application is configured to receive a product order from the user. In some embodiments, the user has a location. In some embodiments, the system further comprises memory storing machine-executable instructions that, upon execution by the one or more computer processors, cause the one or more computer processors to: obtain a plurality of live inventory feeds from the plurality of POS systems; based at least in part on the plurality of live inventory feeds, identify one or more retailers of the plurality of retailers within a maximum distance from the location that have the product in stock; transmit, to POS systems of a subset of the one or more retailers, a fulfilment request; receive a fulfilment response from a POS system of a retailer of the subset of retailers; and based at least in part on a live inventory feed of the retailer and the product order, determining whether to initiate a replenishment order for the retailer.

Another aspect of the present disclosure provides a non-transitory computer readable medium comprising machine executable code that, upon execution by one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a flow chart of distributed drop shipping process, according to some embodiments of the present disclosure;

FIG. 2 schematically illustrates a distributed drop shipping system, according to some embodiments of the present disclosure; and

FIG. 3 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

The present disclosure provides computer-implemented systems and methods for distributed drop shipping. A manufacturer may enroll retailers in a distributed drop shipping program. By enrolling in the distributed drop shipping program, the retailers agree to buy one or more products from the manufacturer and sell those products to customers. The manufacturer may operate one or more consumer-facing digital sales channels, such as a business-to-consumer (B2C) e-commerce website. When a customer places an order on the B2C website, the distributed drop shipping system described herein can identify one or more retailers that are enrolled in the disturbed drop shipping program that are within a maximum distance from the customer's location and have the product in stock. The distributed drop shipping system can determine whether a particular retailer has the product in stock by analyzing the live inventory feed of the retailer. The distributed drop shipping system can transmit a fulfilment request to a subset of the one or more retailers it identified. One of the retailers may fulfill the fulfillment request. By fulfilling the fulfillment request, the retailer may agree to sell the product to the customer. The retailer may ship the product to the customer, or the customer may retrieve the product from a brick-and-mortar retailer front. In return, the retailer may receive payment from the customer, either directly or through the B2C website. The manufacturer may receive a technology fee from the retailer. The manufacturer may determine whether to initiate a replenishment order for the retailer based the inventory feed of the retailer and the product order.

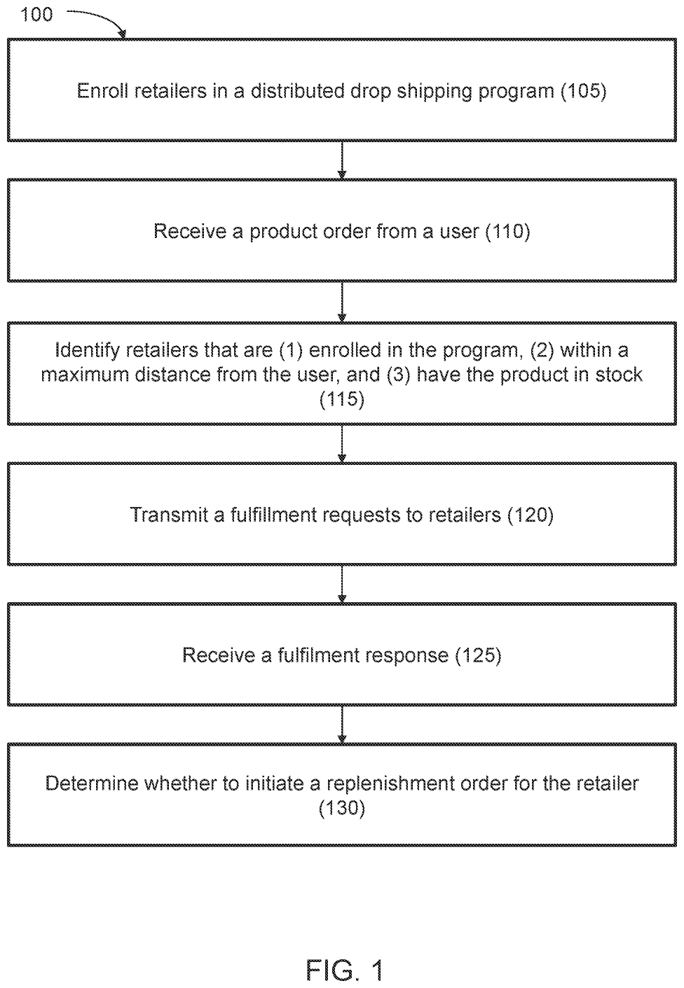

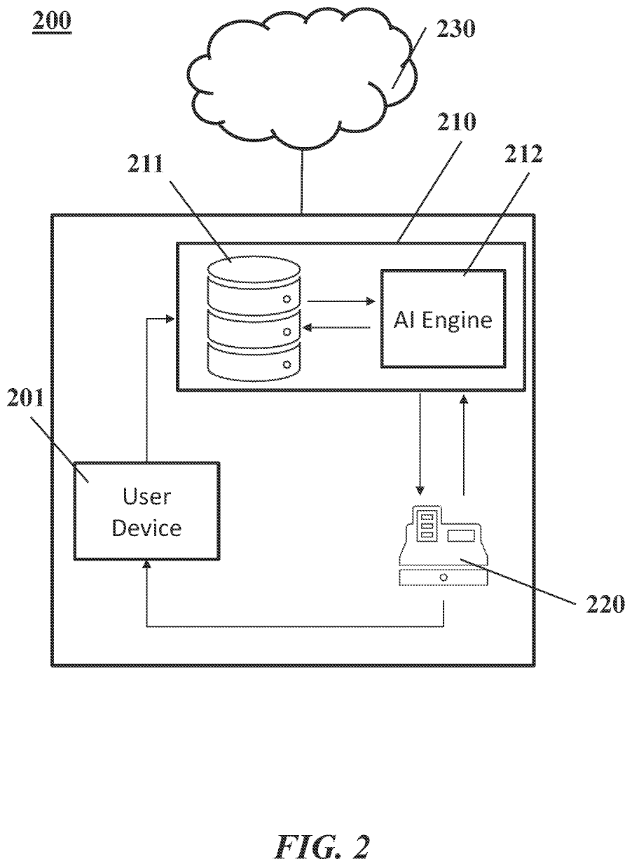

FIG. 1 is a flow chart of a distributed drop shipping process 100. The process may be performed by a system of one or more computers in one or more locations (e.g., the server 210 of the distributed drop shipping system 200 of FIG. 2).

The system can enroll a plurality of retailers in a distributed drop shipping program of a manufacturer (105). In some embodiments, the plurality of retailers may comprise a plurality of autonomous retailers. In some embodiments, the plurality of autonomous retailers can comprise a plurality of retailers, each of which are different from one another. The manufacturer can solicit retailer enrollment through online advertisements, direct marketing, or the like. Enrollment may be conducted through a website maintained by the manufacturer. By enrolling in the distributed drop shipping program, a retailer may agree to buy and hold in inventory one or more products from the manufacturer and sell those products to customers. The system may maintain a database of enrolled retailers and metadata about those retailers (e.g., location, products, shipping capabilities, real-time inventory metrics, etc.)

The system can receive an order from a user (110). In some embodiments, the user may be a consumer. In some embodiments, the user can be an individual (e.g., consumer) who can place the order to purchase a product for themselves. In some embodiments, the user be an individual who can place the order to purchase a product for another. The user can place the order from an application operating on his or her electronic device. The application may be a B2C e-commerce application operated by the manufacturer. The B2C application may have an online marketplace, payment functionality, and the like. The application may be a web application, a mobile application, a standalone application, a web browser plug-in, or the like. The system can run the application through an application server (e.g., the server 210 of FIG. 2).

The order may include one or more products. The order may also include the location of the user. The system can obtain the location automatically from the user's electronic device. The location may be GPS coordinates or a corresponding mailing address.

The system can identify one or more retailers that are (1) enrolled in the distributed drop shipping program, (2) within a maximum distance of the user's location, and (3) have the order product in stock (115). The analyzing may be performed for retailers within a maximum distance from the user's location. The maximum distance from the location (e.g., the distance between the retailer and the location) may be about 0.1 kilometers (km), 0.2 km, 0.3 km, 0.4 km, 0.5 km, 0.6 km, 0.7 km, 0.8 km, 0.9 km, 1 km, 2 km, 3 km, 4 km, 5 km, 6 km, 7 km, 8 km, 9 km, 10 km, 100 km, 200 km, 300 km, 500 km, 1000 km, 2000 km, 3000 km, 4000 km, 5000 km, 10000 km, or more. In some cases, identifying one or more retailers with the product in stock may comprise analyzing live inventory feeds from the retailers. The system can obtain the live inventory feeds on a substantially continuous basis. The system can obtain the live inventory feeds from the point of sale systems of the retailer. Each live inventory feed may include a quantity of products in inventory, an order history, a prediction of future product orders, and the like. In some cases, identifying one or more retailers with the product in stock may comprise analyzing an order history of each of the plurality of retailers. The order history of the retailer may also be used to determine the availability of the product in stock in the retailer.

The system can transmit a fulfillment request to one or more retailers identified in operation 115 (120). In some cases, the system sends the fulfillment request to only a subset of the retailers identified in operation 115. The system can rank the retailers determined in operation 115 to determine the subset of retailers to which the fulfillment request is sent. In some cases, the ranking may be based at least in part on weather at the location and at each of the plurality of retailers. For example, if one or more retailers are a similar distance from the user's location, then a retailer in a location with clear weather may be ranked higher than a retailer with a rainy weather, which may facilitate faster shipping. In some cases, other information such as traffic data between each of the retailers and the location of the user may be used to rank the retailers to determine the subset of retailers that receive the fulfillment request. In some cases, the ranking is based at least in part on the availability of drivers at each of the plurality of retailers. In some cases, the driver may not be located at the retailer. The driver may have a varying location. A distance of the driver to each of the retailers may be used to rank the retailer. The distance between the driver and a retailer may be calculated at a predetermined time. The predetermined time may be the time that an order is received from the user. In some cases, the distance between the driver and the retailer is calculated before the fulfillment request is sent. The fulfilment request may include financial information, including the retailer's expected payment and the manufacturer's technology fee. Retailers may use such financial information to determine whether to accept or reject a fulfillment request.

The system receives a fulfillment response from a retailer (125). In some cases, the system may receive fulfillment responses from multiple retailers. The fulfillment responses may be received simultaneously or serially. In some cases, the system may receive a fulfilment response from one retailer before fulfilment responses from other retailers. In such cases, the system may send a confirmation to the retailer that sent the first fulfillment response. In other cases, the system may use different criteria to select a retailer (e.g., the same or similar criteria used to rank the retailers in operation 120). In general, the system transmits a confirmation to only one retailer. The confirmation may include shipment information for the user, including the user's name and address. In some cases, the confirmation may include a packing slip. After confirmation, the system can send information about the shipment (e.g., the retailer responsible for the shipment, the estimated delivery date, etc.) to the user. The system can send this information through the B2C e-commerce application or through another medium (e.g., email, text message, etc.). In some cases, the user may choose to pick up the product from the retailer. In such cases, the system may provide pick-up instructions instead of shipment information.

In some cases, the system may not receive a fulfillment response. In such cases, the system can repeat operations 115 and 120 and cast a wider net (e.g., increase the maximum distance).

The system can then determine whether to initiate a replenishment order for the retailer that fulfilled the order (130). The determination may be based on the live inventory feed of the retailer and/or the product order. The system may perform this operation on a periodic basis for all of the retailers enrolled in the distributed drop shipping program.

In some embodiments of the process 100, a particular retailer is the sole shipping provider for a manufacturer. The retailer may be a chain retailer with many physical locations. The operations 115, 120, and 125 of the process 100 may be fully automated. In operation 115, the system can identify the chain retailer as the sole shipping provider for a product ordered by a user. In operation 120, the system can transmit a fulfilment request to the chain retailer. The system can send the fulfilment request through an electronic data interchange (EDI). The chain retailer may automatically process the request. For example, the chain retailer can automatically determine which of its physical locations are closest to the user and which locations have the product in stock. In some cases, the chain retailer can automatically perform a financial analysis of the request. For example, the chain retailer can determine whether it would be profitable to accept the fulfillment request based on the retailer's expected payment and the manufacturer's technology fee. After making the above-mentioned determinations, the retailer can automatically accept or reject the fulfilment response. The retailer can send the acceptance or rejection through the EDI. The above-mentioned process may be fully automated, with no human involvement.

FIG. 2 schematically illustrates a distributed drop shipping system 200. The system 200 may include a user device 201, a server 210, and one or more point of sale (POS) systems 220. The user device 201, the server 210, and the one or more PSO systems 220 may communicate over a network 230.

The server 210 can implement the B2C e-commerce application as described previously in this disclosure. The server 210 can serve an instance of the application to the user device 201. The server 210 may also implement the process 200 of FIG. 2. The server 210 may include processing devices, storage devices, and communication devices, including the database 211 and the AI engine 212. The database 211 can store user data, order data, inventory data, and the like. The AI engine 212 can use such data and data acquired in real-time from the POS systems 220 to implement the functionality of the process 200.

The components of FIG. 2 can be implemented on one or more computing devices. The computing devices can be servers, desktop or laptop computers, electronic tablets, mobile devices, or the like. The computing devices can be located in one or more locations. The computing devices can have general-purpose processors, graphics processing units (GPU), application-specific integrated circuits (ASIC), field-programmable gate-arrays (FPGA), or the like. The computing devices can additionally have memory, e.g., dynamic or static random-access memory, read-only memory, flash memory, hard drives, or the like. The memory can be configured to store instructions that, upon execution, cause the computing devices to implement the functionality of the subsystems. The computing devices can additionally have network communication devices. The network communication devices can enable the computing devices to communicate with each other and with any number of user devices, over a network. The network can be a wired or wireless network. For example, the network can be a fiber optic network, Ethernet® network, a satellite network, a cellular network, a Wi-Fi® network, a Bluetooth® network, or the like. In other implementations, the computing devices can be several distributed computing devices that are accessible through the Internet. Such computing devices may be considered cloud computing devices.

### Web Application

In some cases, the user application may be a web application. The web application may allow the user to place an order and receive shipping information or other communications necessary to retrieve a product from a retailer. A web application may be created upon a software framework such as Microsoft® .NET or Ruby on Rails. A web application, in some instances, utilizes one or more database systems including, by way of non-limiting example, relational, non-relational, feature oriented, associative, and XML database systems. Web applications may be written in one or more versions of one or more languages. In some cases, a web application is written in one or more markup languages, presentation definition languages, client-side scripting languages, server-side coding languages, database query languages, or combinations thereof.

### Mobile Application

In some cases, the user application may be a mobile application. The mobile application may run on a mobile device (e.g., an electronic tablet, a smart phone, or a smart watch). The mobile application may allow the user to place an order and receive shipping information or other communications necessary to retrieve a product from a retailer.

Mobile applications may be written in several languages. Suitable programming languages include, by way of non-limiting example, C, C++, C#, Featureive-C, Java™ Javascript, Pascal, Feature Pascal, Python™, Ruby, VB.NET, WML, and XHTML/HTML with or without CSS, or combinations thereof. Suitable mobile application development environments may be available from several sources. Commercially available development environments include, by way of non-limiting example, AirplaySDK, alcheMo, Appcelerator®, Celsius, Bedrock, Flash Lite, .NET Compact Framework, Rhomobile, and WorkLight Mobile Platform. Other development environments may be available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for distribution of mobile applications including, by way of non-limiting example, Apple® App Retailer, Android™ Market, BlackBerry® App World, App Retailer for Palm devices, App Catalog for webOS, Windows® Marketplace for Mobile, Ovi Retailer for Nokia® devices, Samsung® Apps, and Nintendo® DSi Shop.

### Standalone Application

In some cases, the user application may comprise a standalone application, which is a program that may be run as an independent computer process, not an add-on to an existing process, e.g., not a plug-in. Standalone applications are sometimes compiled. In some instances, a compiler is a computer program(s) that transforms source code written in a programming language into binary feature code such as assembly language or machine code. Suitable compiled programming languages include, by way of non-limiting examples, C, C++, Featureive-C, COBOL, Delphi, Eiffel, Java™, Lisp, Python™, Visual Basic, and VB .NET, or combinations thereof. Compilation may be often performed, at least in part, to create an executable program. In some instances, a computer program includes one or more executable complied applications.

### Web Browser Plug-In

In some cases, the user application may comprise a web browser plug-in. In computing, a plug-in, in some instances, is one or more software components that add specific functionality to a larger software application. Makers of software applications may support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types.

In some cases, web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. The web browser, in some instances, is a mobile web browser. Mobile web browsers (also called mircrobrowsers, mini-browsers, and wireless browsers) may be designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Computer Systems

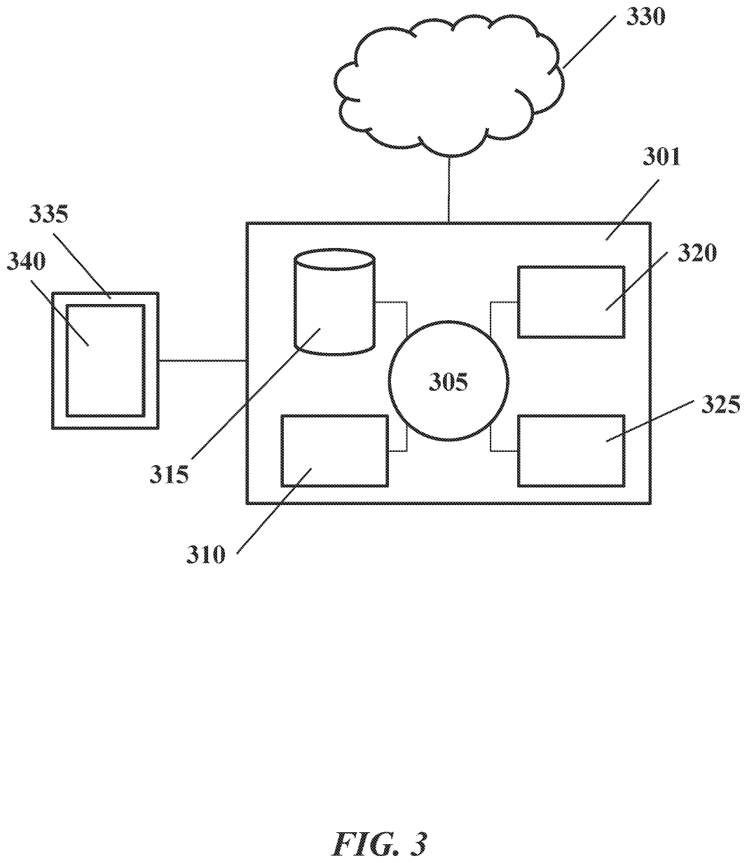

The present disclosure provides computer systems that are programmed to implement methods of the disclosure. FIG. 3 shows a computer system 301 that is programmed or otherwise configured to perform the methods described herein. The computer system 301 can regulate various aspects of the present disclosure, such as, for example, enrolling retailers in a distributed dropship program, receiving a product order from a user, where the user has a location, identifying one or more retailers of the plurality of retailers within a maximum distance from the location that have the product in stock by, for example, analyzing a live inventory feed from each of the plurality of retailers, transmitting, to a subset of the one or more retailers, a fulfilment request, receiving a fulfilment response from a retailer of the subset of retailers, determining whether to initiate a replenishment order for the retailer. The computer system 301 can be an electronic device of a user or a computer system that is remotely located with respect to the electronic device. The electronic device can be a mobile electronic device.

The computer system 301 includes a central processing unit (CPU, also “processor” and “computer processor” herein) 305, which can be a single core or multi core processor, or a plurality of processors for parallel processing. The computer system 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet. The network 330 in some cases is a telecommunication and/or data network. The network 330 can include one or more computer servers, which can enable distributed computing, such as cloud computing. The network 330, in some cases with the aid of the computer system 301, can implement a peer-to-peer network, which may enable devices coupled to the computer system 301 to behave as a client or a server.

The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback.

The CPU 305 can be part of a circuit, such as an integrated circuit. One or more other components of the system 301 can be included in the circuit. In some cases, the circuit is an application specific integrated circuit (ASIC).

The storage unit 315 can retailer files, such as drivers, libraries and saved programs. The storage unit 315 can retailer user data, e.g., user preferences and user programs. The computer system 301 in some cases can include one or more additional data storage units that are external to the computer system 301, such as located on a remote server that is in communication with the computer system 301 through an intranet or the Internet.

The computer system 301 can communicate with one or more remote computer systems through the network 330. For instance, the computer system 301 can communicate with a remote computer system of a user (e.g., a mobile phone, a laptop, a desktop computer, a smart device (e.g., a smart watch, an automated ordering device)). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 301 via the network 330.

Methods as described herein can be implemented by way of machine (e.g., computer processor) executable code stored on an electronic storage location of the computer system 301, such as, for example, on the memory 310 or electronic storage unit 315. The machine executable or machine readable code can be provided in the form of software. During use, the code can be executed by the processor 305. In some cases, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 301 can include or be in communication with an electronic display 335 that comprises a user interface (UI) 340, for example, to obtain a product order from a user, to receive a maximum distance from a user, to provide information associated with the one or more retailers that have the product in stock and are within a maximum distance from the user, and/or to provide to the user shipping information received from the retailer. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm can, for example, enrolling retailers in a distributed dropship program, receiving a product order from a user, where the user has a location, identifying one or more retailers of the plurality of retailers within a maximum distance from the location that have the product in stock by, for example, analyzing a live inventory feed from each of the plurality of retailers, transmitting, to a subset of the one or more retailers, a fulfilment request, receiving a fulfilment response from a retailer of the subset of retailers, confirming a fulfilment response with the retailer from which the fulfillment response is received first, determining whether to initiate a replenishment order for the retailer.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby. The section headings used herein are for organizational purposes only and are not to be construed as limiting the subject matter described.

What is claimed is:

1. A computer-implemented method, comprising:
(a) enrolling a plurality of retailers in a distributed drop shipping program;
(b) receiving a product order from a user, wherein said user has a location;
(c) identifying one or more retailers of said plurality of retailers within a maximum distance from said location that have said product in stock by analyzing a live inventory feed from each of said plurality of retailers or an order history of each of said plurality of retailers;
(d) transmitting, to a subset of said one or more retailers, a fulfilment request;
(e) receiving a fulfilment response from a retailer of said subset of retailers; and
(f) based at least in part on a live inventory feed of said retailer, determining whether to initiate a replenishment order for said retailer.

2. The computer-implemented method of claim 1, wherein (c) comprises analyzing said live inventory feed from each of said plurality of retailers and said order history of each of said plurality of retailers.

3. The computer-implemented method of claim 2, further comprising analyzing a prediction of future product orders from each of said plurality of retailers.

4. The computer-implemented method of claim 1, further comprising, prior to (d), ranking said plurality of retailers to determine said subset of retailers.

5. The computer-implemented method of claim 4, wherein said ranking is based at least in part on a distance from each of said plurality of retailers to said location.

6. The computer-implemented method of claim 5, wherein said ranking is based at least in part on weather at said location and at each of said plurality of retailers.

7. The computer-implemented method of claim 6, wherein said ranking is based at least in part on availability of drivers at each of said plurality of retailers.

8. The computer-implemented method of claim 7, wherein said ranking is based at least in part on a distance of said drivers to each of said plurality of retailers.

9. The computer-implemented method of claim 7, wherein said ranking is based at least in part on traffic between each of said plurality of retailers and said location.

10. The computer-implemented method of claim 1, wherein (e) comprises receiving a plurality of fulfilment responses from a plurality of retailers including said retailer.

11. The computer-implemented method of claim 10, further comprising transmitting a confirmation only to said retailer, wherein said retailer is a first retailer among said plurality of retailers to send said fulfilment response.

12. The computer-implemented method of claim 1, further comprising receiving shipping info from said retailer.

13. The computer-implemented method of claim 1, wherein said product order is an online order.

14. The computer-implemented method of claim 1, wherein said plurality of retailers comprises a plurality of autonomous retailers.

15. The computer-implemented method of claim 1, further comprising maintaining a database of said plurality of retailers comprising data comprising location, products, shipping capabilities, and real-time inventory metrics for each of said plurality of retailers.

16. The computer-implemented method of claim 1, further comprising obtaining said location of said user automatically from an electronic device of said user.

17. The computer-implemented method of claim 1, wherein determining whether to initiate a replenishment order for said retailer is further based at least in part on an order history of said retailer.

18. The computer-implemented method of claim 1, wherein determining whether to initiate a replenishment order is performed periodically for each of said plurality of retailers.

19. The computer-implemented method of claim 1, wherein if a fulfillment response is not received in (e), the method further comprising repeating (c) and (d) until a fulfillment response is received.

20. A distributed drop shipping system, comprising:
a user application on an electronic device of a user, wherein said user application is configured to receive a product order from said user, and wherein said user has a location;
one or more computer processors communicatively coupled to (i) said electronic device of said user and (ii) a plurality of point of sale (POS) systems of a plurality of retailers; and
memory storing machine-executable instructions that, upon execution by said one or more computer processors, cause said one or more computer processors to:
obtain a plurality of live inventory feeds from said plurality of POS systems;
based at least in part on said plurality of live inventory feeds, identify one or more retailers of said plurality of retailers within a maximum distance from said location that have said product in stock;
transmit, to POS systems of a subset of said one or more retailers, a fulfilment request;
receive a fulfilment response from a POS system of a retailer of said subset of retailers; and
based at least in part on a live inventory feed of said retailer, determining whether to initiate a replenishment order for said retailer.
